(19) United States
(12) Patent Application Publication
(10) Pub. No.: US 2009/0298183 A1
(43) Pub. Date: Dec. 3, 2009

(54) METHOD AND APPARATUS FOR ANALYZING ARSENIC CONCENTRATIONS USING GAS PHASE OZONE CHEMILUMINESCENCE

(76) Inventors: Purnendu Kumar Dasgupta, Arlington, TX (US); Ademola David Idowu, Lake Jackson, TX (US); Jianzhong Li, West Chester, PA (US)

Correspondence Address: KAMMER BROWNING PLLC, 7700 BROADWAY, SUITE 202, SAN ANTONIO, TX, 78209, US

(21) Appl. No.: 12/280,700

(22) PCT Filed: Dec. 13, 2006
(86) PCT No.: PCT/US2006/062016

§ 371 Date: Jun. 24, 2009

Related U.S. Application Data
(60) Provisional application No. 60/750,243, filed on Dec. 14, 2005.

(51) Int. Cl. G01N 21/76

(52) U.S. Cl. 436/73; 436/172; 422/52

(57) ABSTRACT

A method of detecting arsenic comprising acidifying at least one sample comprising a known arsenic concentration, reducing arsenic in the sample having the known arsenic concentration to arsine, contacting the arsine in the sample having the known arsenic concentration with a reagent to produce a chemiluminescent emission, measuring the intensity of chemiluminescent emission produced by the sample having the known arsenic concentration, acidifying at least one sample comprising an unknown arsenic concentration, reducing arsenic in the sample having the unknown arsenic concentration to arsine, contacting the arsine in the sample having the unknown arsenic concentration with a photoagent to produce a chemiluminescent emission, measuring the intensity of chemiluminescence emission produced by the sample having the unknown arsenic concentration, and determining the arsenic content in the sample having an unknown arsenic concentration by comparing the intensity of chemiluminescent emission of the sample comprising a known arsenic concentration to the chemiluminescent emission of the sample comprising an unknown arsenic concentration, wherein the arsine is not subjected to a low-temperature trap prior to the reaction with a photoagent.

### STATEMENT REGARDING FEDERALLY SPONSORED RESEARCH OR DEVELOPMENT

This invention is from work sponsored by the National Science Foundation, Grant No. CHE 0456120, Project title A Green Fieldable Analyzer for Arsenic.

### FIELD OF THE INVENTION

The disclosure relates to the measurement of arsenic in aqueous samples. More specifically, this disclosure relates to improved methods for measuring arsenic in aqueous samples by chemiluminescence.

### BACKGROUND OF THE INVENTION

Arsenic (hereinafter called As) is a ubiquitous element. It ranks 20^{th} in abundance in the earth's crust, 14^{th} in seawater and 12^{th} in the human body. The widespread occurrence of inorganic As in water is of concern because of its high toxicity. Inorganic As exists in two oxidation states As(III) and As(V) (often called arsenite and arsenate), the former generally is regarded to be the more toxic form. There is much interest in the areas of toxic effects of arsenic, remediation of polluted sites, and means of detecting and measuring As at trace levels, especially in a field deployable format, with the ability to speciate the two oxidation states.

Methods for measuring arsenic, which are currently approved, for example by the United States Environmental Protection Agency, are based on atomic spectrometric methods. While these instruments can be highly sensitive, they are also bulky, expensive, and typically require large amounts of pure gas in addition to the high cost of consumables making them unsuitable as field instruments.

More affordable calorimetric test kits are presently widely used for arsenic measurement in the field. These are all based on variations of the Gutzeit method, developed over 100 years ago. In the United States, regulations that became effective in February of 2006 specify a maximum permissible level of 10 micrograms per liter (μg/L, parts per billion, ppb) As. In many other countries, as directed by the World Health Organization (WHO), 10 micrograms per liter is already the limit. To attain such a detection limit by the Gutzeit method, a large volume of the water sample is required—this is first made strongly acidic with a proportionate amount of hydrochloric acid (HCl). Zinc metal dust (Zn), that must be scrupulously arsenic free, is then added and causes the reduction of all the As species to arsine (AsH₃). In another version, solid sodium borohydride is used instead of Zn. Sulfides are commonly present in anoxic natural waters. Any sulfide present produces hydrogen sulfide (H₂S) upon acidification. Large amounts of hydrogen (H₂) are produced as well. Hydrogen sulfide will positively interfere in the final color reaction and is therefore first removed by a lead acetate impregnated plug, which does not remove arsine. The arsine gas passes through a mercuric bromide (HgBr₂)-impregnated filter paper, turning it yellow. With increasing concentration of As in the sample, the concentration of arsine increases, and the color becomes a deeper yellow to brown. The color intensity is translated to an arsenic concentration value by visual comparison with a color chart or better, by a photometer.

Although these methods have been improved over the years, the sensitivity is barely adequate for application near the regulation limit (10 ppb) and the use of toxic mercury and lead compounds, which often are improperly disposed off, is not desirable. Sensitive colorimetric methods for detecting the liberated arsine gas have been devised. For example such a method is described in the article entitled “A Speciation-Capable Field Instrument for the Measurement of Arsenite and Arsenate in Water” by Toda, K.; Ohba, T.; Takaki, M.; Karthikeyan, S.; Hirata, S.; Dasgupta, P. K published in the journal Analytical Chemistry, Volume 77, Pages 4765-4773, 2005 and incorporated by reference herein in its entirety. However, large volumes of sample, manual sample handling and complex arrangements are still necessary. Thus, an ongoing need exists to develop relatively inexpensive and field-deployable methods and apparatus for the sensitive detection of arsenic in water samples.

It is known that several hydrides, for example As, selenium, tin and antimony, etc., react with ozone and simultaneous chemiluminescence occurs. This is described in the article entitled “Gas Phase Chemiluminescence with Ozone Oxidation for the Determination of Arsenic, Selenium, Tin and Antimony” by K. Fujiwara, Y. Watanabe, K. Fuwa and J. D. Winefordner published in Analytical Chemistry, volume 54, pages 125-128, 1982 which is incorporated by reference herein in its entirety. The method relevant to As involved acidifying a 20 milliliter water sample with HCl, purging it thoroughly with helium gas to remove air, adding sodium borohydride to produce arsine, purging the reaction vessel with helium gas, removing the water vapor in the effluent with a water trap and collecting the liberated arsine with a liquid nitrogen cooled cryotrap filled with quartz wool. When the cryotrap was warmed to liberate arsine and the arsine was allowed to react with high concentrations of ozone, sensitive detection of arsine was achieved with a state-of-the art photodetector. The same approach was used to determine As in seawater, notably using helium as the carrier gas and cryogenic (liquid nitrogen) collection as described in the article “Ozone Gas-Phase Chemiluminescence Detection of Arsenic, Phosphorus and Boron in Environmental Waters” by K. Fujiwara, H. Tsubota and T. Kumamaru published in Analytical Sciences, Volume 7 Supplement, page 1085-1086, 1991 which is incorporated by reference herein in its entirety.

In 1982, Fraser et al. also independently reported the chemiluminescence reaction of gaseous arsine with ozone and reported on the spectrum of the light produced. These authors did not start from arsenic in solution but used an arsine-nitrogen gas mixture to react with ozone in front of a state-of-the art photodetector and achieved the same detection limit, 0.2 nanograms (ng) of As as that reported by Fujiwara et al. (cited above) in the same year.

Subsequently Fraser and Stedman studied the arsine-ozone chemiluminescence reaction in much greater detail. The authors disclosed arsenic chemiluminescence with ozone results in two bands of light emission, one centered in the ultraviolet at ˜325 nm and the other much broader band in the visible, centered around 450 nm. Light detection in the visible band will be preferred because detectors in the UV are significantly more expensive and even with the added cost are typically not as sensitive. Results reported by Fraser and Stedman showed that in the presence of significant amounts of oxygen the intensity of the visible luminescence band is ˜20 times lower.

Note that the methodology for determining arsenic in water typically used (a) a water trap to remove water from the generated arsine gas, (b) a liquid nitrogen cooled cryotrap to collect the arsine, an inert carrier gas (Helium), and (c) a custom-built, high sensitivity light detection system. Both Fujiwara et al. and Fraser et al. taught the use of pure oxygen as the feed gas to generate ozone so that as much ozone as possible could be produced.

In 1995, Galbãn et al. attempted to make a practical laboratory measurement method based on this principle. They reported on the simultaneous determination of As(III) and trivalent antimony (Sb(III)) based on the fact that the wavelengths of light emission are different. They omitted the cryotrap, leaving most other things the same. They used a large benchtop top-of-the-line luminometer of the time, equipped with a high end phototube (Perkin Elmer, model LS 50). However, they reported that only weak and irreproducible chemiluminescence signals could be obtained. They actually photoexcited the sample and looked at it in the phosphorescence mode.

Galbãn et al still taught:
(i) the use of a salt-ice bath as a water trap,
(ii) very high ozone concentrations and the use of oxygen as ozonizer feed,
(iii) highest photomultiplier tube voltage possible applied to the instrument to improve sensitivity while stating that it reduced the lifetime of the detector,
(iv) the use of an inert carrier gas: He, Ar or N₂ could be used as the carrier gas to carry the arsine to the chemiluminescence chamber.
   With this arrangement and using a sample volume of 3 milliliters (mL), Galbãn et al could only achieve a limit of detection 50 micrograms per liter.

Hydrides such as H₂S produce luminescence exclusively in the UV that an UV-insensitive detector will not be able to see. If the hydride analytes are present in the gas phase, selective detection of individual hydrides may be possible by wavelength discrimination as disclosed in French Patent application 8110316, May 25, 1981 which is incorporated by reference herein in its entirety. The different hydrides also have different speeds of reaction with ozone. The reaction with arsine is slower and it may be possible to use a first reaction chamber to react away the faster reacting components before detecting the chemiluminescence due to the arsine-ozone reaction in a second chamber as described in UK patent application GB 2 163 553 A, Feb. 26, 1986 which is incorporated by reference herein in its entirety.

While some of the lessons from direct measurement of gas phase analytes by reactions with ozone may be applicable, measuring aqueous analytes constitute a separate problem. For example, while several gaseous hydrides do react with ozone to generate chemiluminescence, many of these hydrides such as those of phosphorus or boron cannot be generated from aqueous solutions. Generation of aqueous solutions also obligatorily generate a large amount of water vapor.

To generate arsine from an arsenic solution by a liquid phase chemical reagent, an aquous solution of sodium borohydride, NaBH₄, is the preferred agent. Prior literature suggests the use of a few % NaBH₄ dissolved in water (Fujiwara et al., 1991) or in 0.1 M NaOH (Fujiwara et al., 1982). Neither of these reagents is stable for more than a few days. The need to frequently prepare a reagent is undesirable.

It is known that in lieu of a chemical reducing agent, electrical reduction at the cathode in strongly acidic solutions can be used to generate arsine from dissolved arsenic (III) as shown in reaction 1:

As³⁺+5H⁺+8e⁻→AsH₃(g)+H₂(g) (1)

This is described in the article entitled “Electrochemical and Chemical Processes for Hydride Generation in Flow Injection ICP-MS: Determination of Arsenic in Natural Waters” by L. F. R. Machado, A. O. Jacintho, A. A. Menegário, E. A. G. Zagatto, M. F. Giné, published in the Journal of Analytical Atomic Spectrometry, Volume 13, Pages 1343-1346, 1998 which for example used a platinum cathode to reduce As(III) to AsH₃. Any As(V) present had to be chemically pre-reduced to As(III) first using a cocktail of ascorbic acid, potassium iodide and thiourea. Such a reduction step requires significant time and still is not complete—it does not produce the same sensitivity as As(III) (see for example Flow Injection Electrochemical Hydride Generation Atomic Absorption Spectrometry (FI-EHG-AAAS) as A Simple Device for the Speciation of Inorganic Arsenic and Selenium, U. Pyell, A. Dworschak, F. Nitschke and B. Neidhart, Fresenius Journal of Analytical Chemistry. Volume 363, pages 495-498, 1999). Pyell et al. successfully reduced As(III) to AsH₃ on both lead and fibrous carbon cathodes but were able to get only 70% of the response from As(V) when the latter was chemically pre-reduced to As(III). \check{S}evaljević et al. (A New Technique of Arsenic Determination Based on Electrolytic Arsine Generation and Atomic Absorption Spectroscopy, M. M. \check{S}evaljević, S. V. Mentus and N. L. Marjanović, Journal of the Serbian Chemical Society, Volume 66, Pages 419-427, 2001) also used platinum electrodes, were able to reduce only As(III) and suggested that addition of copper and tin salts, along with hydroxylamine, greatly accelerated the arsine formation. Such terms are relative, the half-time for arsine evolution ranged from ˜3 to >7 min.

Although most studies of electrolytic As(III) reduction have been carried out for preparative purposes at large concentrations of dissolved As(III) (see for example Electrochemical Isolation of Dispersed Arsenic from Aqueous Alkaline Solutions of Sodium Arsenite, M. K. Smirnov, A. V. Smetanin, A. P. Tomilov and A. V. Khudenko, Russian Journal of Electrochemistry, Volume 35, pages 249-252, 1999; Process and Device for the Electrolytic Generation of Arsine, P. Bouard, P. Labrune and P. Cocolios, U.S. Pat. No. 5,425,857, Jun. 20, 1995), it is known that the electrolytic reduction of As(III) is possible on a variety of metals, the two principal products are elemental As (which is often the goal, as for example in the work of Smirnov et al., above) and AsH₃. Aside from the cathode material, the pH of the solution has a strong influence on the relative amounts of As and AsH₃ produced. According to Smirnov et al. above, there is only one “metal” that produces 100% yield of arsine (in strongly acid solutions). That metal cannot be used in analytical applications designed to measure trace arsenic: that metal is arsenic itself. Because much of the extant literature is on reductions involving very high concentrations of arsenic that talk in terms of relative current efficiencies of the yield of As and AsH₃, respectively (see for example, Electroreduction of As(III) in Acid Environment, M. K. Smirnov, A. V. Smetanin, V. V. Turygin, A. V. Khudenko and A. P. Tomilov, Russian Journal of Electrochemistry, Volume 37, pages 1050-1053, 2001) on different cathode materials, it is very difficult to derive information from these studies that is directly applicable to the analytical scale. For example, the yield of AsH₃, relative to that of As, may desirably increase at high current densities (several kA/m²). In small scale analytical apparatus, Joule heating and other considerations may make such current densities impractical.

The electrochemical reduction of As(V):

As⁵⁺+5H⁺+10e⁻→AsH₃(g)+H₂(g)

is not easily attained on a platinum cathode but there are reports that this reduction can be attained on lead, cadmium, or amalgamated silver electrodes. The reported efficacy or superiority of different electrode material varies greatly. Chernykh et al. (Electrochemical Reduction of Arsenic Acid, I. N. Chernykh, A. P. Tomilov, A. V. Smetanin and A. V. Khudenko, Russian Journal of Electrochemistry, Volume 37, Page 942-946, 2001) suggest that As(V) is reduced to arsine with four times better current efficiency on cadmium compared to lead cathodes. In contrast, Denkhaus et al. (Electrolytic Hydride Generation Atomic Absorption Spectrometry for the Determination of Arsenic, Antimony, Selenium and Tin—Mechanistic Aspects and Figures of Merit, Fresenius Journal of Analytical Chemistry. Volume 370, pages 735-743, 2001) suggest that lead is better than cadmium. Both sets of authors agree that at least on a cadmium cathode, higher current densities lead to better and more efficient AsH₃ production. Regardless of electrode material, As(V) is not reduced to AsH₃ except under strongly acid conditions. The work of Denkhaus et al. is likely the most definitive in the context of electrochemical reduction of As in either oxidation state to AsH₃, it is their position that elemental As is always first deposited on the cathode before it is reduced to the hydride.

Commonly, electrochemical reduction of aqueous As to AsH₃ for analytical applications has used atomic spectrometry as the analytical detection method. The manner in which this is implemented typically involves a flow-injection configuration. The sample containing arsenic is injected into a liquid carrier which continuously flows through the cathode compartment of an electrochemical cell. The arsenic in the sample is reduced to arsine during this passage. The evolved gases, by far the bulk of which is H₂, contain the AsH₃ thus formed. The gas is separated from the cathode liquid effluent by a gas-liquid separator following the electrochemical cell and flows to the atomic spectrometer. It is obvious that mass transfer to the cathode in the liquid phase can be the rate limiting factor in attaining efficient reduction to arsine. For the same reason, the preferred electrochemical cell construction is of the planar, thin-layer type and catholyte flow rate must be limited.

It will be apparent from the above description that the liquid flow in the system must be carried out in a continuous way, requiring continuous pumping systems and will not operate in an intermittent batch mode. It will also be apparent that arsine is evolved through the entire time the sample passes through the cell. A broad wide peak will result, compromising the attainable detectability. Trying to confine the evolved gas in a container defined by a gas-liquid membrane, such as that advocated by Denkhaus et al., can at best result in limited success, liquid leaks through such membranes with use. Cryotrapping the arsine, as practiced by Pyell et al., can be successful but constitute a complex means that is of little use in a needed field deployable instrument.

### SUMMARY OF THE INVENTION

Disclosed herein is a method of detecting arsenic comprising acidifying at least one sample comprising a known arsenic concentration, reducing arsenic in the sample having the known arsenic concentration to arsine, contacting the arsine in the sample having the known arsenic concentration with a reagent to produce a chemiluminescent emission, measuring the intensity of chemiluminescent emission produced by the sample having the known arsenic concentration, acidifying at least one sample comprising an unknown arsenic concentration, reducing arsenic in the sample having the unknown arsenic concentration to arsine, contacting the arsine in the sample having the unknown arsenic concentration with a photoagent to produce a chemiluminescent emission, measuring the intensity of chemiluminescence emission produced by the sample having the unknown arsenic concentration, and determining the arsenic content in the sample having an unknown arsenic concentration by comparing the intensity of chemiluminescent emission of the sample comprising a known arsenic concentration to the chemiluminescent emission of the sample comprising an unknown arsenic concentration, wherein the arsine is not subjected to a low-temperature trap prior to the reaction with a photoagent.

Also disclosed herein is a method of detecting arsenic comprising separating a sample into at least two portions, adjusting the pH of a first portion to equal to or less than about 1, adjusting the pH of a second portion to about 4, reacting the first and second portion separately with a reducing agent to generate a first arsine sample and a second arsine sample, reacting the first and second arsine samples separately with ozone to generate a chemiluminescence emission, and determining the amount of arsenic present in each sample portion based on the intensity of the chemiluminescence emission.

Further disclosed herein is a method of detecting arsenic comprising separating a sample into at least two portions, adjusting the pH of a first portion to equal to or less than about 1, reducing the first portion with a first cathode to generate a first arsine sample, reducing the second portion with a second cathode to generate a second arsine sample, reacting the first and second arsine samples separately with ozone to generate a chemiluminescence emission, and determining the amount of arsenic present in each sample portion based on the intensity of the chemiluminescence emission.

Further disclosed herein is an apparatus for the measurement of arsenic in a sample comprising a fluid distribution system for the conveyance of fluids, an arsine generation system in fluid communication with the fluid distribution system and receiving fluids from the fluid distribution system, a chemiluminescence emission system in fluid communication with the arsine generation system and a photosensor, and receiving at least a portion of the sample generated from the arsine generation system, and a detection device coupled with the photosensor, wherein the sample may comprise arsenic in solution and the conveyance of fluids from the fluid distribution system to the arsine generation system and to the chemiluminescence emission system is synchronized.

Further disclosed herein is a method of detecting arsenic comprising adjusting the pH of a portion of a sample to about 4, contacting the portion with a reducing agent to generate a first arsine sample, contacting the first arsine sample with ozone to generate a chemiluminescence emission, adjusting the pH of the first portion to less than about 1, contacting the portion with a reducing agent to generate a second arsine sample, contacting the second arsine sample with ozone to generate a second chemiluminescence emission, and determining the amount of arsenic present in the trivalent and pentavalent oxidation states, based on the intensity of the first and second chemiluminescence emission.

### BRIEF DESCRIPTION OF THE DRAWINGS

FIG. 1 shows an overview of an arsenic detection apparatus.

FIG. 2 shows a schematic of an arsenic detection apparatus.

FIG. 3 shows a system schematic of an arsenic analyzer based on chemical hydride generation.

FIG. 4 shows a schematic of a reaction cell on the photomultiplier tube.

FIG. 5 shows the typical amplified photomultiplier tube output for total As using chemical hydride generation.

FIG. 6 shows recovery of As (V) in a spiked local groundwater sample.

FIG. 7 shows comparison of the present method data with USGS data

FIG. 8 shows the signal variation with pH using 10 μg L⁻¹ As (III) and 10 μg L⁻¹ As (V).

FIG. 9 shows typical system output for 10 μg L⁻¹ As (III) at pH 4.

FIG. 10 shows recovery of As(III) in a spiked local groundwater sample.

FIG. 11 shows system schematics of the electrolytic arsine generator (EAG).

FIG. 12 is an exploded view of an electrochemical cell.

FIG. 13 shows typical amplified photomultiplier tube output for As (III) standards, using electrolytic arsine generator.

### DETAILED DESCRIPTION OF THE INVENTION

Disclosed herein are methods and apparatuses for the detection of arsenic in an aqueous sample. Said methods comprise the reduction of arsenic to arsine and the subsequent reaction of arsine with a reagent to produce light. In an embodiment, the disclosed methods allow for the further characterization of the nature of the arsenic within said sample.

In an embodiment, a method for measuring arsenic in an aqueous sample comprises the reduction of arsenic to arsine and the subsequent reaction of arsine with a reagent that may result in a detectable event such as for example chemiluminescence that may serve as an indicator of the presence and amount of arsenic in said sample. The reduction of arsenic to arsine may be carried out chemically, electrolytically or combinations thereof.

In an embodiment, the sample comprises arsenic in an aqueous solution or suspension. In some embodiments, the sample comprises arsenic in a mixture of aqueous and nonaqueous solutions or suspensions. Alternatively, the sample comprises arsenic that may be extracted into aqueous solution such as for example by leaching. In some embodiments, the arsenic in the aqueous sample comprises inorganic arsenic. The methods disclosed herein may be suitable for detecting inorganic arsenic at concentrations equal to or greater than about 50 ppb, alternatively equal to or greater than about 40 ppb, alternatively equal to or greater than about 30 ppb, alternatively equal to or greater than about 20 ppb, alternatively equal to or greater than about 10 ppb, alternatively equal to or greater than about 1 ppb. As will be understood by one of ordinary skill in the art, the upper limit for As detection may be affected by numerous factors and samples having high concentrations of As may be adjusted such as for example by dilution so as to render the As amounts within a range convenient for measurement.

In an alternative embodiment, the arsenic in the aqueous sample comprises organic arsenic. The organic arsenic may be component of a largely carbon-containing compound such as for example and without limitation monomethylarsonic acid or dimethylarsinic acid. In such embodiments, the methods disclosed herein may allow for the measurement of at least a portion of the organic arsenic present in the aqueous samples.

In an embodiment, the method for the measurement of arsenic in an aqueous sample comprises acidification of the aqueous sample. Methods for acidifying an aqueous sample comprising arsenic are known to one of ordinary skill in the art and include for example and without limitation contacting the sample with an acid or an acid-generating compound. Such acids or acid-generating compounds include for example and without limitation acids such as hydrochloric acid or sulfuric acid; buffers such as phosphate buffer or citrate buffer or combinations thereof. As will be described in detail later herein, the extent of acidification of the sample will depend on the measurements desired by the user and can be adjusted accordingly. Furthermore, it is to be understood that such acid or acid-generating compounds may contain small amounts of inorganic arsenic. In some embodiments, the acid or acid-generating compound may be pretreated to reduce the amount of inorganic arsenic present in the compound. Alternatively, the contribution of the arsenic in the acid or acid generating compound to the arsenic level of the water-containing sample may be determined by methods to be described herein.

In an embodiment, the method for the measurement of arsenic in an aqueous sample comprises the chemical reduction of the arsenic in the sample to arsine. Hereafter methods comprising the chemical reduction of arsenic to arsine are termed CR methods. In an alternative embodiment, the method for the measurement of arsenic in an aqueous sample comprises the electrolytic reduction of arsenic to arsine. Hereafter methods comprising the electrolytic reduction of arsenic to arsine are termed ER methods.

In an embodiment, a CR method for measuring arsenic in an aqueous sample comprises the chemical reduction of arsenic to arsine. The chemical reduction of arsenic to arsine may be carried out using a reducing agent. Herein a reducing agent has its definition as known to one of ordinary skill in the art as the electron donor in an oxidation reduction reaction. In an embodiment, any reducing agent capable of reducing arsenic to arsine and compatible with the other components of the sample may be employed. Such reducing agents are known to one of ordinary skill in the art and include for example and without limitation sodium borohydride, zinc metal or combinations thereof. In an embodiment the reducing agent is sodium borohydride. The reduction of arsenic by sodium borohydride is known to one of ordinary skill in the art and may be represented by chemical equation 1:

3NaBH₄+4H₃AsO₃→4AsH₃(g)+3H₃BO₃+3NaOH (1)

In an embodiment, the reducing agent is sodium borohydride which may be used as aqueous solution. The sodium borohydride may be present in an amount of from about 0.1 to about 10 weight % (wt. %). In an alternative embodiment, the reducing agent is a sodium borohydride composition (SBC). The SBC may comprise sodium borohydride, a strong base and a chelating agent. In an embodiment, the SBC comprises sodium borohydride present in an amount of from about 0.1 wt. % to about 10 wt. %, a strong base present in an amount of from about 0.1 M to about 2 M, and a chelating agent present in an amount of from about 0.1 mM to about 100 mM. Strong bases and chelating agents are known to one of ordinary skill in the art. For example and without limitation a strong base suitable for use in this disclosure comprises potassium hydroxide while a chelating agent may comprise ethylenediaminetetraacetic acid.

In an embodiment, an ER method for measuring arsenic in an aqueous sample comprises the electrolytic reduction of arsenic to arsine. The electrolytic reduction may be carried out utilizing any cathode and anode combination capable of effecting the reduction of arsenic to arsine. In an embodiment, the arsenic may be converted to arsine by electrolytic reduction on a cadmium, platinum or lead cathode at pH<1. In some embodiments, the electrolytic reduction of arsenic may be carried out on a stainless steel cathode. In such embodiments, the stainless steel cathode may only allow for the reduction of As(III) to arsine. Such specificity of reduction may be exploited to differentiate the amount of As(III) and As(V) present in a sample as will be described in more detail later herein. Electrolytic reduction involves the passage of a current through solution resulting in the transfer of electrons from arsenic to the cathode with the overall reduction reaction being given by chemical equation (3):

H₃AsO₄+8e⁻+8H⁺→AsH₃+4H₂O (3)

The voltage and time required for the reduction of As to arsine will depend on numerous factors and may be determined by one of ordinary skill in the art to meet the needs of the user.

In an embodiment, method for measuring arsenic in an aqueous sample further comprises the reaction of arsine with a reagent to produce a detectable signal such as for example a chemiluminescence (CL) emission. In an embodiment the reagent is ozone and the arsine may be reacted with ozone in a specially configured cell to produce chemiluminescence (CL) emission. CL is defined herein as the emission of ultraviolet, visible, or near-infrared radiation through the chemical excitation of a reacting species. The specially configured cell will be described in detail later herein. The reaction of arsine and ozone can be represented by chemical equation (2):

O₃+AsH₃→AsO(⁴II)+AsO [symbol] (AsO)₂*→2AsO+hν (2)

In most cases of CL, a chemical reaction results in an excited intermediate that emits radiation upon relaxation to its ground electronic state. Without wishing to be limited by theory, the proposed arsenic intermediate responsible for the observed luminescence emission is (AsO)₂. The intensity of the CL emission is known to be directly proportional to the concentration of arsenic in the sample.

CL may be detected through the use of any means known to one skilled in the art for the detection of light. Alternatively, the CL emission is detected through the use of a photomultiplier tube (PMT). PMTs herein refer to sensitive light detectors that multiply the signal produced from incident light from which single photons are detectable. Such detectors are well known in the art. The PMT may be a component of an apparatus designed for the detection of a luminescence emission.

In an embodiment, the method for the measurement of arsenic in an aqueous sample further comprises subjecting at least one aqueous sample having a known amount of As to the methodologies disclosed herein and detecting the CL emission. The intensity of the CL emission for the known sample may then be compared to the CL emission for an aqueous sample containing an unknown amount of As and used to quantitate the amount of As in the unknown sample. In an alternative embodiment, at least two aqueous samples having a known amount of As are subjected to the methodologies disclosed herein and the intensity of the CL emissions of those samples detected. These intensities may then be used to generate a calibration curve which may be used to determine the amount of arsenic in aqueous sample containing an unknown amount of As. Methods for the generation of a calibration curve based on the intensity emissions of at least two samples containing a known amount of As would be apparent to one of ordinary skill in the art.

In an embodiment, the method for measuring arsenic in an aqueous sample disclosed herein may further comprise distinguishing the oxidation state of the arsenic in the sample. In such an embodiment, the oxidation state of the arsenic in the sample may be characterized by conducting the measurements as a function of acid concentration or pH. The pH of the sample may be adjusted through the use of any means known to one skilled in the art for adjustment of the pH and compatible with the other components of the sample. For example, such methods may involve the use of buffers. For example, at a pH of less than about 1, both As(III) and As(V) are converted to arsine. Hereafter As(III) and As(V) are referred to as the total As. However, at a pH of about 4 only As(III) is converted to arsine.

In an embodiment, a CR method for differentiating the arsenic in an aqueous sample based on the oxidation state comprises separating the sample into at least 2 portions. One portion of the sample may be subjected to measurement of the inorganic arsenic at a pH of less than about 1 to determine total As while a second portion is subjected to measurement at a pH of from about 3 to about 5 to determine As(III). The arsenic may be measured using the methodology disclosed previously herein. In an alternative embodiment, the pH of an aqueous sample comprising arsenic is adjusted to about 4. The amount of arsenic in the sample in the form of As(III) may then be determined at this pH. The pH of the sample may then be reduced to equal to or less than about 1 and the amount of total arsenic in the sample determined. In such embodiments, sodium borohydride or an SBC may be used as the reducing agent.

In an embodiment, a ER method for distinguishing the oxidation states of As in an aqueous sample comprises separating the sample into at least two portions wherein one portion is subjected to reduction of the arsenic to arsine at a pH equal to or less than about 1 using a stainless steel cathode. The second portion of the sample may then be reduced using a cadmium or lead cathode. In such an embodiment only As(III) is converted to arsine with the stainless steel cathode while the total As is converted when employing the cadmium or lead cathode. For both the ER and CR methods, the determination of total As and As(III) may aid in the identification of the arsenic source compound.

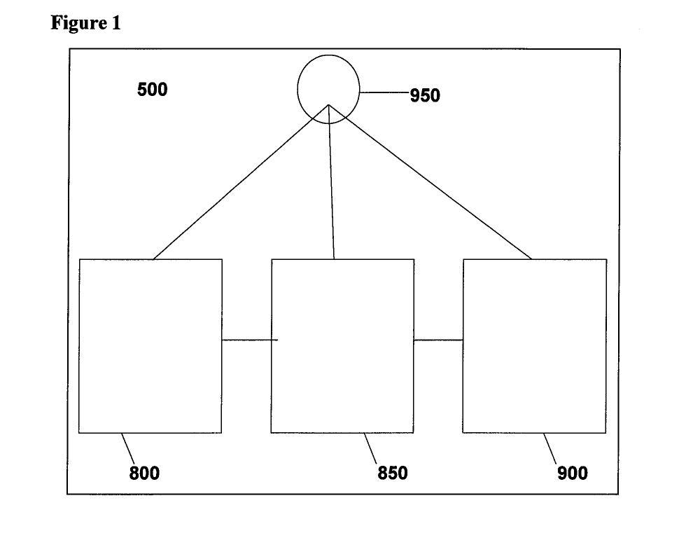

An embodiment of an apparatus 500 for use in the measurement of arsenic in aqueous samples is schematized in FIG. 1. In an embodiment, an arsenic detection apparatus (ADA) 500 comprises a fluid distribution system (FDS) 800 coupled to and upstream of an arsine generation system (AGS) 850 which in turn is coupled to and upstream of a chemiluminescence emission/detection system (CES) 900. These systems may be operated manually, may be automated or combinations thereof. In an embodiment, the ADA 500 is a fully automated apparatus which may be controlled by controlling device 950 coupled to FDS 800, AGS 850, and CES 900, which functions to control the ADA 500 as a whole or the individual components of the ADA 500. In such embodiments, the movement of fluids from the FDS 800 to the AGS 850 and then to the CES 900 may be synchronized so as to allow the analysis of the arsenic levels in the samples in a reduced time period. In an embodiment, an aqueous sample containing arsenic may be introduced to the ADA 500 by uptake into the FDS 800 which in turn conveys the sample and reactants to the AGS 850 for the production of arsine. The arsine generated in the AGS 850 may then be conveyed to the CES 900 for reaction with a reagent which generates a CL emission that can be measured and subsequently used to quantitate the amount of arsenic in the aqueous sample.

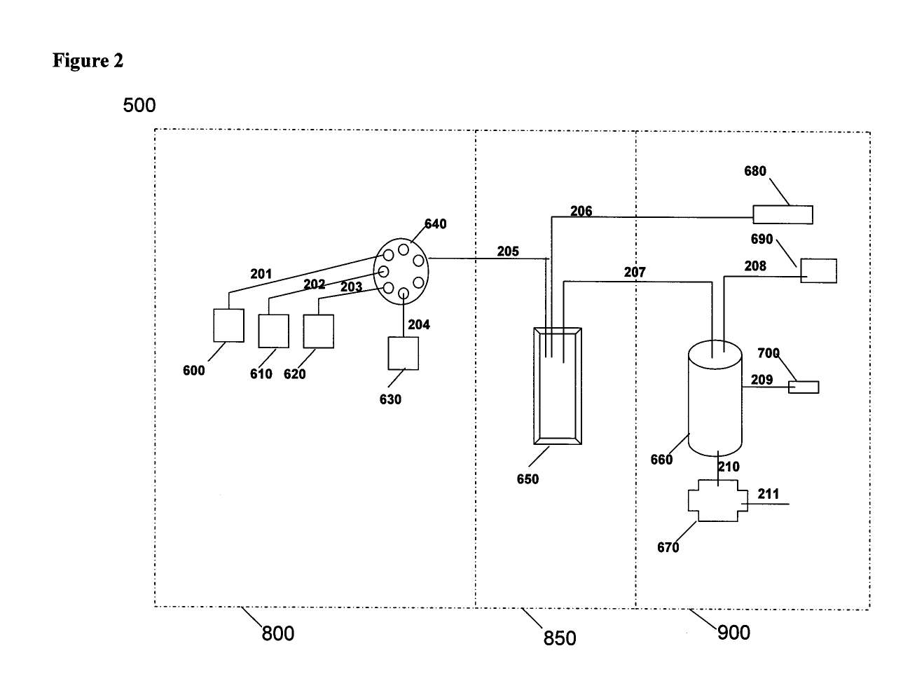

Referring now to FIG. 2, an ADA 500 may comprise a FDS 800 which comprises a fluid distribution device 630 coupled through flowline 204 to a multiport valve 640, which is in fluid communication with reservoirs 600, 610, 620 and AGS 850 (e.g., reactor vessel 650) through flowlines 201, 202, 203 and 205, respectively. In an embodiment, a sample may be introduced to fluid distribution device 630, which in turn may convey the sample to multiport valve 640 through flowline 204 and/or to reactor vessel 650 through flowline 205. In such an embodiment the valve is positioned so as to allow flow from fluid distribution vessel 630 to multiport valve 640 and/or to reactor vessel 650. It is to be understood that the valve may be positioned to allow fluid flow from the fluid distribution device 630 to the reactor vessel 650, from any of the reservoirs 600,610,620 to the reactor vessel 650 or combinations thereof. Alternatively, the valve may be positioned so as to allow for the flow of samples from the fluid distribution device 630 or the flow of fluids from the reservoirs 600, 610, 620 to the multiport valve 640 where they may reside for some time before being conveyed to the reactor vessel 650. As such, multiport valve 640 regulates the flow of fluid from flow distribution device 630 and reservoirs 600, 610, 620 to the reactor vessel 650 and may prevent the backflow of components from the reactor vessel 650. The fluid distribution device 630 and any of the reservoirs may house an aqueous sample that is believed or known to have some amount of arsenic. In an embodiment, a sample may be introduced to ADA 500 from the fluid distribution device 630 or one or more of the reservoirs 600, 610, 620, alternatively one or more samples may be introduced to the ADA through the use of an autosampler. The autosampler may be coupled directly to the multiport valve 640 or may be coupled to a reservoir 600, 610, 620 such that at least a portion of the sample is conveyed from the autosampler to the reservoir for introduction to the AGS 850. It should be understood that number of ports in the multiport valve and the number of reservoirs may be varied to meet the needs of the user such that the number of ports and reservoirs depicted in FIG. 2 is only for illustrative purposes. Furthermore, the use of multiple single port valves arranged in parallel or in series may also be contemplated. Multiport valve 640 may be a manually operated or may be controlled by another device such as for example a controller or a computer having a user interface and allowing for input of control parameters (not shown).

Referring again to FIG. 2, the aqueous sample containing arsenic and other fluids (e.g. reaction components) housed in reservoirs 600, 610, 620 may be conveyed via multiport valve 640 to reactor vessel 650 via flowline 205. On/off valves and/or multiport valve 640 may interrupt various flowlines allowing for the conveyance of the samples from the FDS 800 to the AGS 850 and the CES 900 to be controlled manually or automated for example through the use of electrical signals. For example, the aqueous sample containing arsenic may first be conveyed to reaction vessel 650. Then an acid, such as for example sulfuric acid, may conveyed from a reservoir and allowed to contact and acidify the sample residing in reactor vessel 650. The sample may optionally be contacted with additional components for the generation of arsine as has been previously described herein. Such embodiments are described in the Examples below.

Referring to FIG. 2, the AGS 850 comprises a reactor vessel 650, and a flowline 207 for conveyance of the arsine to a CES 900. In an embodiment, samples and reagents once having entered reactor vessel 650 may be optionally agitated utilizing for example an air flow device 680 which may allow the generation of air at a specified flow rate which enters reaction vessel 650 through flowline 206. In an embodiment, the samples are reduced chemically and the reactor vessel 650 may be a container that allows for the contacting of the sample, the reducing agent and under components described previously herein. Alternatively, the samples are reduced electrolytically and reactor vessel 650 may be an electrochemical cell that allows the generation of arsine at the cathode. Each of these types of reactor vessels are described in more detail in the Examples.

Embodiments having more than one AGS 850 in the ADA 500 are also contemplated. The AGS may comprise electrolytic reduction vessels, chemical reduction vessels or both and the AGS may be arranged in series or in parallel. For example, the AGS may comprise at least two electrolytic cells wherein each cell contains a different cathode, for example one reactor vessel may comprise a stainless steel cathode while a second reactor vessel comprises a cadmium cathode. In such embodiments a sample or portions of a sample may be reduced in the different reactor vessels to differentiate the oxidation states of arsenic in a sample. For example, the portion of the sample conveyed to the reactor vessel containing the stainless steel cathode would have only the As(III) in the sample converted to arsine while that portion conveyed to the reactor vessel containing the cadmium cathode would have total As converted to arsine. The samples may be allowed to reside in reactor vessel 650 for a time period sufficient to reduce at least a portion of the arsenic in the sample to arsine and at least a portion of the sample conveyed from reactor vessel 650 to the CES 900 (e.g., CL cell 660) via flowline 207.

CL cell 660 may be a vessel comprised of an opaque material with at least one surface of the CL cell comprised of a clear or transparent material to allow for detection of CL emissions occurring from the cell. Ozone may be generated using an ozone generation device 690 and conveyed to the CL cell 660 via flowline 208. CL cell 660 may further comprise a flowline 209 that would allow for the venting of any unreacted gas such that the pressure within the CL cell may remain near ambient. In an embodiment, flowline 209 may be equipped with a filter 700 that would allow for the destruction of any reactive gas (e.g., ozone) exiting the CL cell 660 prior to that line being vented to the open atmosphere. In an embodiment the CL cell has a clear bottom that is coupled 210 (e.g., in electronic or signal communication) to a photosensor 670 such that CL emissions occurring in the CL cell may be detected by the photosensor 670. The photosensor may further be coupled 211 to at least one device for the recording, conversion and optional storage of the information obtained from the CL emissions.

In an embodiment, the ADA 500 may further comprise one or more devices coupled to the apparatus such that the mixture residing in the reactor vessel 650, the CL cell 660 or both may be subjected to analysis. Such analysis may require that at least some portion of the mixture be removed from the apparatus. Alternatively the devices may operate to determine properties of the mixtures while still contained within the ADA 500.

The methods described herein may be carried out manually, may be automated, or may be combinations of manual and automated processes. In an embodiment, the devices described herein may be controlled manually, may be automated or combinations thereof. In an embodiment, the method is implemented via a computerized apparatus having the features disclosed herein, wherein the method described herein is implemented in software on a general purpose computer or other computerized component having a processor, user interface, microprocessor, memory, and other associated hardware and operating software. The software implementing the method may be stored in tangible media and/or may be resident in memory, for example, on a computer. Likewise, input and/or output from the software, for example ratios, comparisons, and results, may be stored in a tangible media, computer memory, hardcopy such as a paper printout, or other storage device.

The methods and apparatus disclosed herein utilize the intense chemiluminescence emission produced when arsine reacted directly with ozone in front of a photomultiplier tube window in the presence of significant amounts of water vapor and excess air or oxygen to measure the amount of arsenic in aqueous samples. Furthermore, the methods and apparatuses disclosed herein may be used in the absence of a low-temperature trap (i.e. liquid nitrogen, salt-ice baths) or a non-air carrier gas.

The methodology and apparatus disclosed herein utilizes the differential generation of arsenie as a tool for separating arsenic from many potentially interfering species that may be present in a natural water matrix. Furthermore, the automation of the methodology and apparatus described herein may allow for the continuous monitoring and measurement of the amount of arsenic in aqueous samples in a portable, field-deployable instrument. In an embodiment, a field-deployable instrument is a portable instrument that is self-contained, self-powered (e.g., have a battery or other power supply) and sized such that it may be readily transported and deployed by a single user. Alternatively, the portable instrument may be connected to an external power supply, for example a generator, a standard 110V power outlet, a 12V DC automotive power outlet, etc. For example, the instrument may be sized about equal to or smaller than an airline carry-on bag (e.g., about 22L×14W×9H inches), about equal to or smaller than a typical briefcase (e.g., about 16-18L×11-14W×3-6H inches), or about equal to or smaller than a laptop computer (e.g., about 10-16L×8-12W×1-2H inches). In an embodiment, all components of the instrument as shown in the Figures and describes herein may integrated within a common housing, for example a ruggedized housing sized as described previously. Furthermore, in various embodiments, the field-deployable instrument may have computer control integral therein, or may be connected to a separate computer device (e.g., a laptop) to provide all or a portion of the computer control. In various embodiments, the field-deployable instrument may weigh less than about 25, 20, 15, 10, or 5 pounds. In an embodiment, the methods and apparatuses disclosed herein may allow for the measurement of arsenic in aqueous samples in less than about 5 minutes, alternatively less than about 2 minutes, alternatively less than about 1 minute.

### EXAMPLES

The invention having been generally described, the following examples are given as particular embodiments of the invention and to demonstrate the practice and advantages thereof. It is understood that the examples are given by way of illustration and are not intended to limit the specification of the claims in any manner.

### Example 1

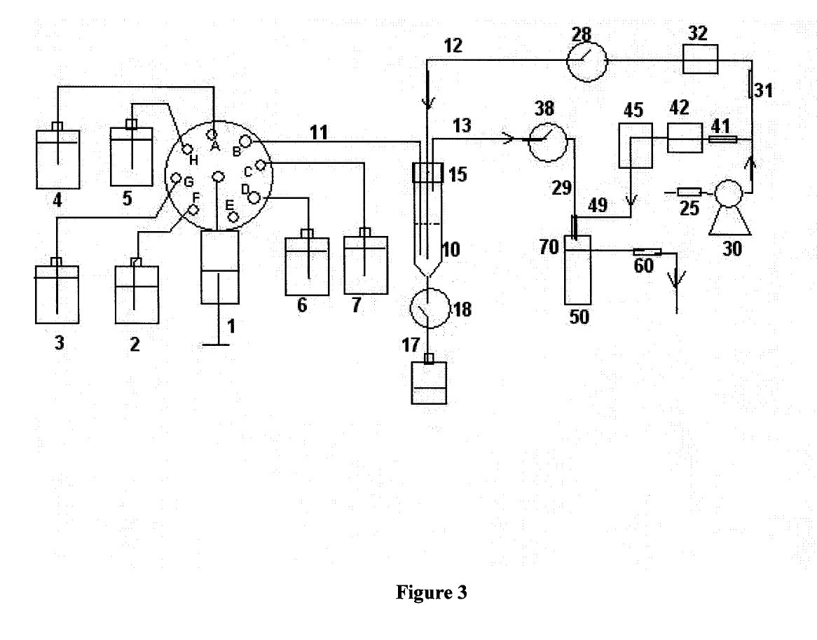

The instrument used for the measurement of inorganic arsenic in an aqueous sample is schematically shown in FIG. 3. The bi-directional syringe pump 1 (model 54022, Kloehn Ltd., Las Vegas, Nev.) was equipped with a 10-mL capacity glass syringe (Kloehn model 19110) and an 8-port motorized distribution valve (Kloehn model 19323) with ports A-H that connected to the syringe, one at a time. All flow conduits were polytetrafluoroethylene (PTFE) tubes, except as stated otherwise. The sequence of operation, volumes (up to the maximum capacity of the syringe), and syringe operational speeds were programmable. Reactants or samples were sequentially aspirated from containers 2-7 to the reactor 10, made from a 30-mL capacity polyolefin disposable syringe.

The upper end of reactor 10 was fitted with three tubes 11-13 passing through a rubber stopper 15, while the lower end has an on/off solenoid valve 18 (Biochem valve Corp., Boonton, N.J., model 075T2) connected by exit tube 17. Electrical power was applied in a programmed fashion to valve 18 to open the fluid passage and allow the liquid in 10 to be drained to waste 16. Reactor inlet tube 11 comes from port B of the multiport valve connected to pump 1.

Inlet tube 11 terminates towards the bottom of reactor 10. This tube 11 was used for the dispensing of all liquids, e.g., acid from container 2, buffer from container 3, sample from container 5 (or in lieu of a container, this conduit is connected to a sample source such as an autosampler or a process pipe) and sodium borohydride from container 6, respectively, to the reactor 10. Tube 11 was 0.3 mm in inner diameter and the minimum length was used to reduce the holdup volume of the tube. Tube 12 carried air drawn through activated carbon filter 25 and pumped by miniature DC air pump 30 (model T2-03 HP. Parker-Hannifin inc.) via capillary flow restrictor 31 that controlled the air flow at 20 standard cubic centimeters per minute (sccm) via optional flow meter 32 and optional on/off solenoid valve 28 (Biochem valve Corp., Boonton, N.J., model 075T2) to agitate the liquid mixture, and to drive off arsine from the liquid phase to the gas phase. A flow range from 5-50 sccm is acceptable. Filter 25 also serves to remove reactive hydrocarbons that may produce chemiluminescence with ozone. Tube 13 terminates just inside reactor 10 at the top.

With all necessary chemicals added, arsine is generated in the reactor along with much larger amounts of hydrogen gas. Arsine and hydrogen flowed out through tube 13 through optional on/off solenoid valve 38 (Biochem valve Corp., Boonton, N.J., model 075T2) when turned on, through opaque black PTFE tube 29 into externally opaque ozone chemiluminescence reactor 70. Air pump 30 continuously pumped the carbon-filtered air via capillary flow restrictor 41 that controlled the air flow at 60 sccm, via optional flow meter 42 through miniature ozone generator 45 (model EOZ-300Y, www.ozone.enaly.com, Shanghai, China) through opaque black PTFE tube 49 to ozone chemiluminescence reactor 70. An ozone flow in the range of 20-250 sccm is acceptable. The bottom window of reactor 70 is transparent so miniature photosensor module 50 (model H5874, Hamamatsu Inc.) can register any emitted light and produce a corresponding signal. The exit gas from the chemiluminescence reactor 70 was vented through a catalyst such as activated carbon or activated manganese oxide (Carulite, Carus Chemical) cartridge 60 also through an opaque tube, to prevent the release of ozone into the ambient air. Passage through cartridge 60 catalytically destroyed the ozone. Reactor 70, photosensor module 50 and associated components were put into a separate light tight enclosure to minimize the intrusion of external light. The particular photosensor module 50 responds in the wavelength range 300-650 nm with peak response at ˜450 nm. The electrical output of the photosensor module was offset and further amplified by a two-stage operational amplifier based circuit.

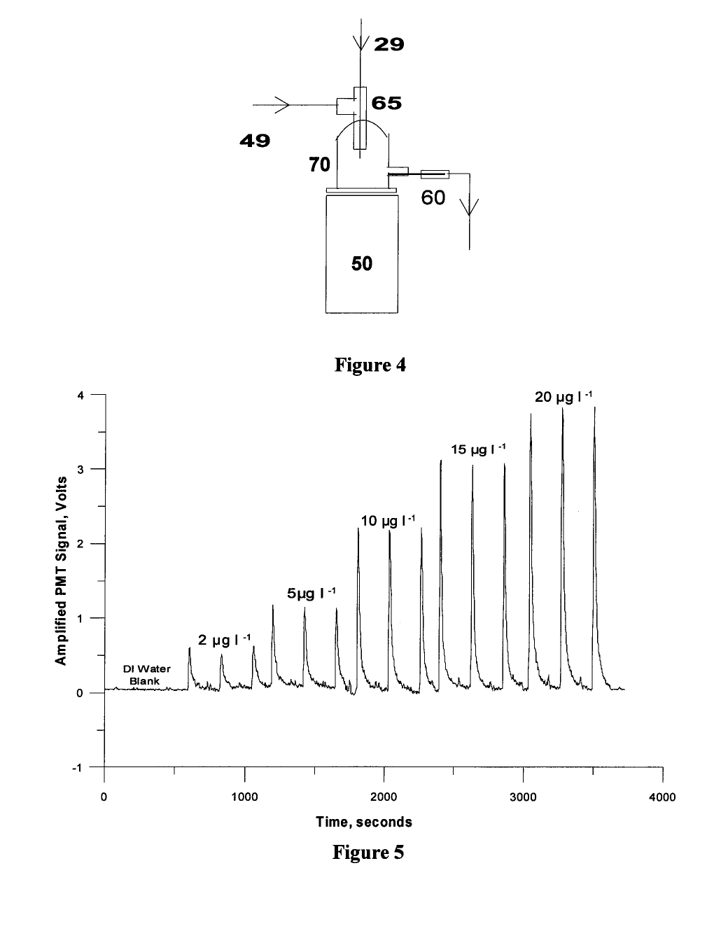

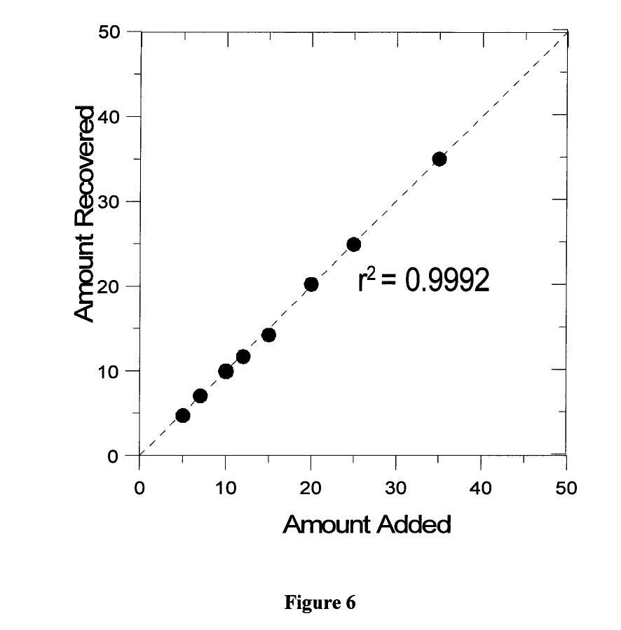

The details of chemiluminescence reactor cell 70 and photosensor module 50 are shown in FIG. 4. The cell itself was made from the bottom of a 8 mm diameter glass test tube, which when inverted produced a hemispherical top and a cylindrical bottom with a contained volume of 2 mL. The cell was silvered externally to provide a reflective interior and then covered externally with heavy black paint. Other ovoid and spheroid cells of volume between 0.5 and 5 mL can also be successfully used. The arsine/hydrogen conduit 29 and the ozone conduit 49 entered reactor cell 70 in an annular arrangement and were separated at a ozone-inert polyvinyledene fluoride tee 65 such that by retracting the position of 29 within 49, the pre-read reaction time between the arsine and ozone could be increased before the mixture actually entered the chemiluminescence reactor cell 70. The gas entrance point was located about 2 cm from the sensor window.

The instrument was controlled by a computer. A typical operational sequence was as follows.

(i) Sample (3 mL) was aspirated into the syringe pump 1 from container 5 through port H.

(ii) The distribution valve of 1 was switched to port B, and the sample was dispensed into the reactor 10.

(iii) The distribution valve of 1 was switched to port G and 1 mL of 0.5 molar potassium acid phthalate (KHP, pH 4) was aspirated.

(iv) The distribution valve of 1 was switched to port B, and the buffer was dispensed into the reactor 10.

(v) The distribution valve of 1 was switched to port C and 2 mL of water was aspirated from container 7.

(vi) The distribution valve of 1 was switched to port A, and the syringe rinse water was dispensed into waste container 4.

(vii) Steps (v) and (vi) were repeated (up to two times).

(viii) The distribution valve of 1 was switched to port D, 1 mL of the sodium borohydride reagent (2% NaBH₄ in 0.1 M NaOH) was aspirated.

(ix) The distribution valve of 1 was switched to port B, and the sodium borohydride reagent was dispensed into the reactor 10.

(x) In this example, optional valves 28 and 38 were not present and air was purging the solution in reactor 10 throughout. As NaBH₄ was added arsine and hydrogen were generated and these gases were purged by the air stream to the chemiluminescence reactor cell 70. The system was made to wait 100 seconds in this condition for the arsine to be fully purged and the resulting light signal detected and be recorded on the control computer which also functioned as the data acquisition and display system.

(xi) Valve 18 was now opened to drain the reactor contents.

(xii) Valve 18 was closed, the distribution valve of 1 was switched to port C and 10 mL water was aspirated.

(xiii) The distribution valve of 1 was switched to port B, and the water was dispensed into reactor 10 to rinse it.

(xiv) Valve 18 was now opened to drain the reactor contents.

(xv) Valve 18 was closed and the system returned to step 1 to analyze the next sample.

The sequence above constitutes one analytical cycle and measures only As(III). The analytical cycle requires under 4 minutes to complete.

### Example 2

This example was identical to example 1 except that steps (v)-(vii) were replaced by:

(v) The distribution valve of 1 was switched to port C and 10 mL of water was aspirated from container 7.

(vii) The distribution valve of 1 was switched to port A, and the syringe rinse water was dispensed into waste container 4.

This was a faster means of washing the cell compared to example 1 but it wasted more water.

### Example 3

This example was identical to example 1 above, except that steps (iii)-(iv) were replaced by:

(iii) The distribution valve of 1 was switched to port F and 1 mL of 1 molar sulfuric acid was aspirated.

(iv) The distribution valve of 1 was switched to port B, and the acid was dispensed into the reactor 10.

This procedure resulted in the measurement of Total As.

### Example 4

This example was identical to example 3 above, except that steps (v)-(vii) were replaced by:

(v) The distribution valve of 1 was switched to port C and 10 mL of water was aspirated from container 7.

(vii) The distribution valve of 1 was switched to port A, and the syringe rinse water was dispensed into waste container 4.

This was a faster means of washing the cell compared to example 1 but it wasted more water.

### Example 5

This example was identical to example 4 above except that optional valves 28 and 38 were in place and initially remained closed. After the NaBH₄ reagent was added in step (ix), 10 seconds reaction time was allowed. This built up some pressure in the reactor. When they were opened, the accumulated gases were quickly purged to the chemiluminescence reactor cell 70.

The response obtained to various concentrations of As (V) containing samples is shown in FIG. 5. In this example, the control voltage applied to the photosensor module 50 was 0.8 V. According to the manufacturer (http://jp.hamamatsu.com/resources/products/etd/pdf/m-h5784e.pdf), the output at this control voltage is ˜4×10¹⁰ volts per watt of incident light, about 20% of the maximum gain of 2×10¹¹ volts per watt of incident light obtained at a control voltage of 1.0 V.

The linear calibration equation for the data shown in FIG. 5 was:

Peak height(Volts)=(0.1634±0.0065)+(0.1796±0.0025)As(V), μg/L, r²=0.9896

Based on a signal to noise ratio of 3, the detection limit is 0.2 μg/L.

The same experiment was done with As(III) containing samples. The calibration equation obtained was:

Peak height(Volts)=(0.1437±0.0083)+(0.1772±0.0028)As(III), μg/L, r²=0.9975

This is statistically identical to the calibration equation previously described indicating that the total As measurement technique does measure As (III) and As(V) with equal sensitivity. This also suggests that either As (III) or As (V) standards can be used for Total As calibration.

Under the above conditions, the upper measurement limit was ˜60 μg/L (0-60 μg/L linear r² 0.9940), at which point the upper input limit of the data acquisition card was reached. The correlation coefficient utilizing peak areas instead of peak heights for the same data was 0.9930. The upper applicable limit was easily extended to 1200 μg/L by reducing the photosensor control voltage to 0.72 V (linear correlation coefficient r² for 0-1200 μg/L was 0.9890).

### Example 6

This experiment was conducted identically to example 5. The total arsenic content of local tap water was repeatedly measured over an extended period. The maximum concentration found was 3.1 μg/L. Over the same period, the city of Lubbock analytical laboratories reported an arsenic concentration that varied between 0.5 and 4.1 μg/L determined by atomic spectrometry methods.

### Example 7

This experiment was conducted identically to example 5. A high salt local groundwater sample (specific conductance 4.7 millisiemens/cm) was first analyzed for total As and then spiked with various concentrations of As(V). The plot of the recovered vs. added spike concentration is shown in FIG. 4 and the mathematical linear relationship could be described as:

Recovered Total As, μg/L=0.242±0.011+1.006±0.008 Spiked Total As, μg/L, r²=0.9992

### Example 8

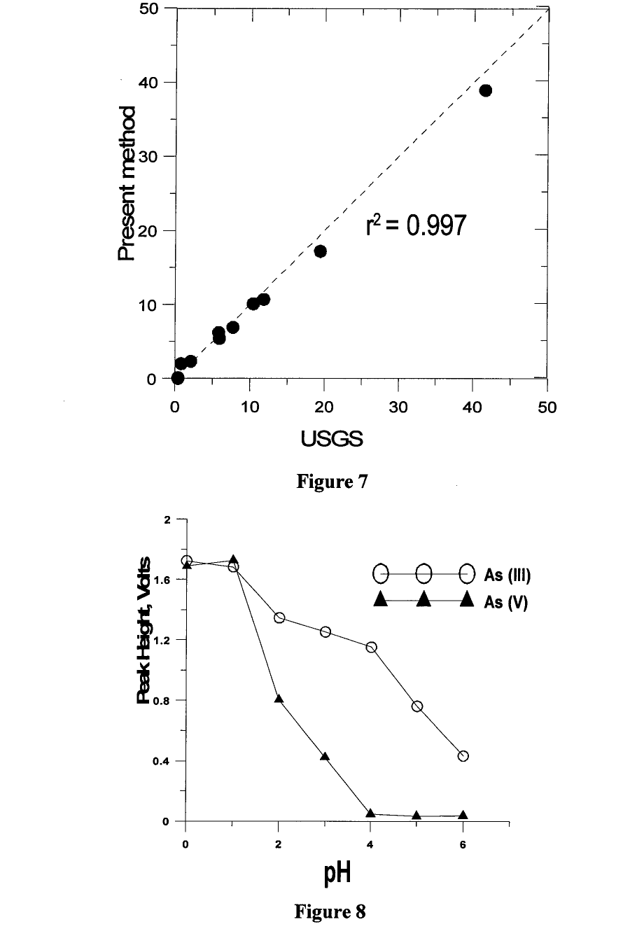

This experiment was conducted identically to example 5 except that only 1 mL sample was used. The samples were EDTA-preserved acid mine drainage samples collected by the United States Geological Survey (USGS) analyzed by them using High Performance Anion Exchange Chromatography—Hydride Generation—Induction Coupled Plasma Mass Spectrometry (details of the sinstrumentation used can be seen for example in: Field and Laboratory Arsenic Speciation Methods and Their Application to Natural-Water Analysis, A. J. Bednar, J. R. Garbarino, M. R. Burkhardt, J. F. Ranville, T. R. Wildeman, Water Research, Volume 38, 355-364, 2004) and supplied blind to the inventors. Both the inventor's laboratory and the USGS used independent standards for individual system calibration. The results of this experiment for the eleven samples are shown in FIG. 7. Two of the samples registered below the limit of detection in the USGS assay and one of them was below the limit of detection in the present method as well. Following customary practice, for numerical analysis and plotting, it is assumed that these respective samples have been measured at half of the limit of detection of the respective methods. The relationship found was:

Total As (present method), μg/L=0.9305±0.0119 Total As (USGS), μg/L, r²=0.9972, n=11

While the slope is not perfectly unity, the USGS analysis showed that a small amount of the As in 7 of the 11 samples were organic which, as will be shown below do not register as sensitively as inorganic As in the method of the present disclosure.

### Example 9

This experiment was conducted identically to example 5 except that organic As species were used as test samples. Monomethylarsonic acid (MMA) and dimethylarsinic acid (DMA) both have As in the +5 oxidation state. These compounds were tested in the 10-60 μg/L As concentrations. MMA produced a response 65% of that of inorganic As while DMA produced a response 15% of that of inorganic As. Note that these species do not produce arsine but the corresponding monomethyl and dimethyl derivatives. The respective boiling points of AsH₃, CH₃AsH₂, and (CH₃)₂AsH are −55, 2, and 36° C. respectively. Without wishing to be limited by theory, these may be increasingly remaining in the water phase and not purged to the reactor. Alternatively methylation may be decreasing reactivity towards ozone in a stepwise manner.

### Example 10

This experiment was conducted identically to example 5 except to determine interference from common anions, anions were added variously in the range of 1-100 mg/L (bearing in mind the concentrations they occur in drinking water) in the presence of As at the As regulatory level of 10 μg/L. As shown in Table 1 below, no significant interference was found.

TABLE 1

| Potential Interference | Experimental value of |
|---|---|
| (concentration) added to 10 μg/L | Total As Determined, |
| As(V) solution | μg/L |
| Sulfide (1 mg/L) | 9.7 ± 0.2 |
| Silicate (1 mg/L) | 9.5 ± 0.2 |
| Nitrate (10 mg/L) | 9.6 ± 0.2 |
| Phosphate (10 mg/L) | 9.4 ± 0.2 |
| Chloride (100 mg/L) | 9.7 ± 0.2 |
| Sulfate (100 mg/L) | 10.2 ± 0.2 |
| Carbonate (100 mg/L) | 9.3 ± 0.2 |

Note that much larger amounts of sulfate is present in sulfuric acid added as part of the assay. In the groundwater spike recovery experiments, the water sample contained much larger amounts of chloride and sulfate than examined above.

### Example 11

This experiment was conducted identically to example 5 except to determine interference from tin and antimony. The concentration of tin necessary to elicit the same chemiluminescence signal as 10 μg/L As was 1.1 mg/L. The concentration of antimony necessary to elicit the same chemiluminescence signal as 10 μg/L As was determined to be 0.6 mg/L. These concentrations are much higher than what would be encountered for these elements in drinking water.

### Example 12

This experiment was conducted identically to example 5 except to determine the effect of the pH of the arsine generation solution. The 1 M H₂SO₄ solution (taken to be pH ˜0) in container 2 was replaced alternately with 0.1 M H₂SO₄ (taken to be pH ˜1), 0.2 M KCl to which sufficient HCl was added for the pH to read 2, 0.5 M KHP to which sufficient HCl was added for the pH to read 3, 0.5 M KHP with a native pH of 4, 0.5 M KHP to which sufficient NaOH was added for the pH to read 5 and the pH 6 solution was made with 0.5 M potassium dihydrogen phosphate (KH₂PO₄) to which 2 M NaOH was added until the desired pH was reached. These solutions were used as the acid/buffer in steps (iii) and (iv) of example 1.

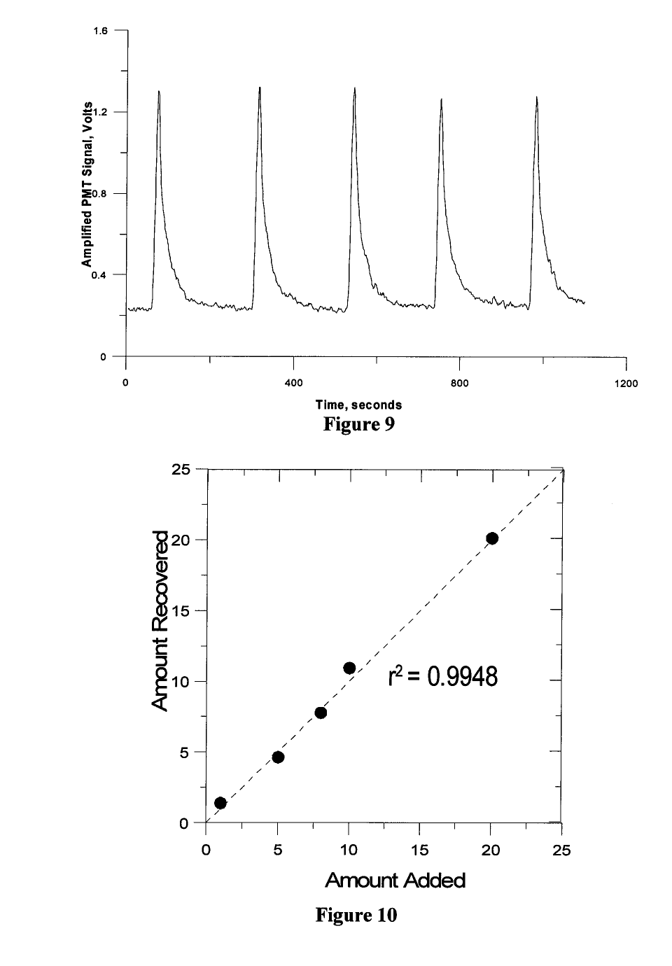

FIG. 8 shows the signals obtained for pure As(III) and As(V) standards as a function of pH. It is readily observed that <pH 1 both As(III) and As(V) respond and with equal sensitivity. At pH 4, As(V) no longer responds while As(III) still responds, with ˜60-70% of the sensitivity exhibited at pH<1. Measurement at pH 4, as in examples 1 and 2 thus selectively measured As(III).

### Example 13

This experiment was conducted identically to example 2 to determine As(III). For 0-60 μg/L As(III), the following linear response equation is obtained:

Peak height, Volts=(0.1050±0.0093)+(0.1049±0.0009)As(III), μg/L, r²=0.9981

This sensitivity is about 60% of that obtained for As(III) at pH<1. A typical system output for a sample containing 10 μg/L As(III) is shown in FIG. 9.

Based on a signal to noise ratio of 3, the limit of detection is 0.3 μg/L As(III).

When As(III) and Total As can be separately determined, As(V) in a sample can be determined by difference.

### Example 14

Identical to Example 13 above, As(III) in local tap water samples was determined as in Example 6. No As(III) was ever found above the detection limit. This is consistent with the practice of chlorination for disinfection in the city water supply. It is known that free chlorine and As(III) cannot coexist.

### Example 15

Identical to Example 13, As(III) was determined. Similar to Example 7 in a high salt local groundwater sample (specific conductance 4.7 milliSiemens/cm) was first analyzed for As(III) and then spiked with various concentrations of As(III). The plot of the recovered vs. added spike concentration is shown in FIG. 10 and the mathematical linear relationship could be described as:

Recovered Total As, μg/L=0.124±0.014+1.006±0.019 Spiked Total As, μg/L, r²=0.9948

### Example 16

Identical to Example 13, As(III) was determined. Similar to Example 10 to determine interference from common anions, anions were added variously in the range of 1-100 mg/L (bearing in mind the concentrations they occur in drinking water) in the presence of As(III) at the As regulatory level of 10 μg/L. As shown in Table 2 below, perceptible negative interference was found only in the case of carbonate, where the large amount of carbonate apparently effectively changed the pH of the arsine generation conditions.

TABLE 2

| Potential Interference | Experimental value of |
|---|---|
| (concentration) added to 10 μg/L | Total As Determined, |
| As(V) solution | μg/L |
| Sulfide (1 mg/L) | 9.8 ± 0.3 |
| Silicate (1 mg/L) | 9.3 ± 0.3 |
| Nitrate (10 mg/L) | 9.3 ± 0.3 |
| Phosphate (10 mg/L) | 9.6 ± 0.3 |
| Chloride (100 mg/L) | 9.8 ± 0.3 |
| Sulfate (100 mg/L) | 10.6 ± 0.3 |
| Carbonate (100 mg/L) | 8.9 ± 0.2 |

No discernible interference was accordingly found when 100 mg/L carbonate was added as bicarbonate.

Note that much larger amounts of sulfate is present in sulfuric acid added as part of the assay. In the groundwater spike recovery experiments, the water sample contained much larger amounts of chloride and sulfate than examined above.

### Example 17

Identical to Example 16 above, interference from tin and antimony was investigated. The concentration of tin necessary to elicit the same chemiluminescence signal as 10 μg/L As(III) was determined to be 1.1 mg/L. The concentration of antimony necessary to elicit the same chemiluminescence signal as 10 μg/L As was determined to be 0.6 mg/L. These concentrations are much higher than what would be encountered for these elements in drinking water.

### Example 18

This experiment was conducted identically to example 5 to determine total As except to determine the effect of reagent stability. All containers were stored at room temperature. Calibration experiments for Total As was run every day. Up to a period of 5 days, there was no change of calibration slope but after that time, a decrease in response was perceptible.

### Example 19

This experiment was conducted identically to example 18 above except that in container 6 the NaBH₄ reagent was composed of 2% NaBH₄ in 1 M KOH and in container 2 the H₂SO₄ solution was composed of 2 M H₂SO₄. All containers were stored at room temperature. Calibration experiments for Total As were run every few days. Up to a period of 25 days, there was no change in calibration slope. After 30 days, the response decreased by 12%.

### Example 20

This experiment was conducted identically to example 19 above except that in container 2 the H₂SO₄ solution was composed of 1.5 M H₂SO₄. All containers were stored at room temperature. Calibration experiments for Total As were run every few days. Up to a period of 25 days, there was no change in calibration slope. After 30 days, the response decreased by 12%.

### Example 21

This experiment was conducted identically to example 18 above except that in container 6 the NaBH₄ reagent is composed of 4% NaBH₄ in 2 M KOH and in container 2 the H₂SO₄ solution is composed of 2 M H₂SO₄ and 0.6 mL of the NaBH₄ solution is aspirated and delivered in steps viii and ix of example 1. All containers are stored at room temperature. Calibration experiments for Total As are run every few days. For a period of 30 days, there is no perceptible change in response.

### Example 22

Examples 19-21 demonstrated greater stability of the NaBH₄ reagent as the base content of the reagent is increased. This experiment investigated the effect of temperature. The experiment is identical to Example 18 except that the NaBH₄ reagent is stored in a well-insulated Peltier-cooled enclosure at 5° C. Calibration experiments for Total As are run every few days. Up to a period of 45 days, there is no change in calibration slope.

### Example 23

Examples 19-21 demonstrated greater stability of the NaBH₄ reagent as the base content of the reagent is increased or the storage temperature is decreased. This experiment was aimed at investigating the use and stability of NaBH₄ in organic solvents such as acetonitrile and ethylene glycol. Either the desired amount of NaBH₄ could not be dissolved or there is no improvement in stability. Instrument detection limits also suffers.

### Example 24

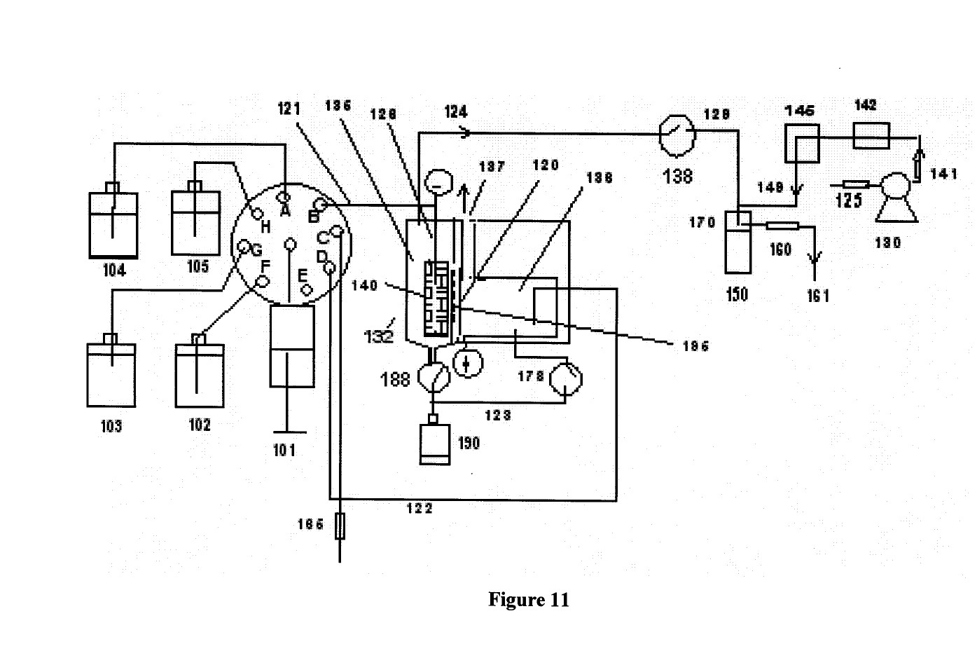

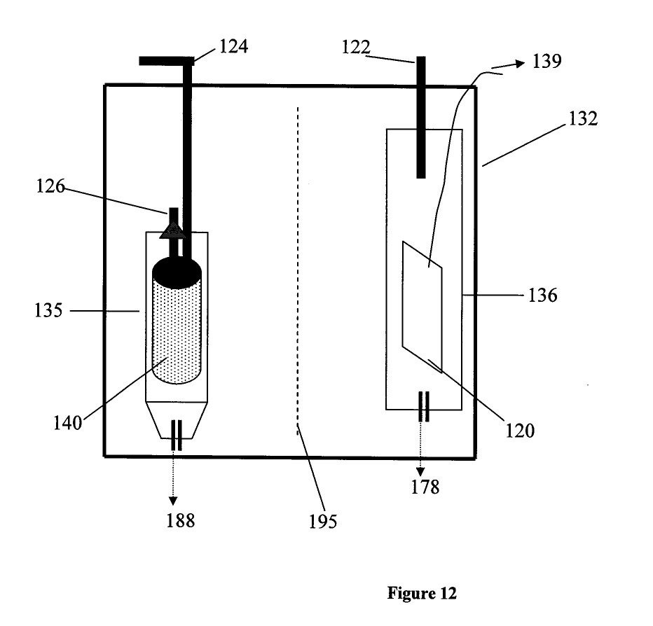

A second embodiment of this disclosure uses electrochemical reduction of arsenic as shown in FIG. 11. In this arrangement a bidirectional syringe connected to a multiport distribution valve 101 addressed different liquid containers 102-105 in much the same way as that in the system of FIG. 1. The ozone generation and chemiluminescence measurement system, comprising of inlet carbon filter 125, miniature air compressor 130, flow restrictor 141, optional flow meter 142, ozone generator 145, ozone carrying opaque tube 149, opaque tube 129 carrying arsine/hydrogen from on/off valve 138, chemiluminescence reactor 170, photosensor 150, reactor exit tube 161 and reactor exit filter 160 were the same as their counterparts in FIG. 1 and served the same purpose. It is the electrochemical hydride generator 132 and its associated components that were different. An exploded view of the electrochemical hydride generator is shown in FIG. 12.

Referring to FIG. 12, electrochemical hydride generator 132 comprises an enclosed cathode chamber 135 separated from anode chamber 136 by ionically conductive reinforced ion exchange membrane 195 (reinforced membrane Nafion 417, Sigmaaldrich.com). The anode chamber 136 contained a platinum screen anode 120 and was vented through the opening 137. The platinum screen anode 120 was placed as close to the membrane 195 as possible to minimize the i-R drop. The platinum connecting wire to the anode was brought out through a compression fitting in the wall of chamber 139 and was connected to a lead wire. A power supply (0-12 V, up to 2 A) was connected to the two electrodes with the platinum connected to the positive terminal. The cathode chamber 135 contained a cylindrical porous metal cathode 140 made of stainless steel (Mott porous metal products, Farmington, Conn.) with stainless steel tube 126 firmly connected to it. Tube 126 exited cathode chamber 135 through a leak-proof compression fitting. Tube 126 provided for electrical connection as the cathode and once outside cathode chamber 135, connected to polymer tube 121 (not shown) that connected to port B of distribution valve of syringe pump 101. The cathode chamber 135 had a conical bottom to facilitate complete drainage and was connected to on/off solenoid valve 188 which drains to waste bottle 190 when turned on. The anode chamber 136, substantially larger than the cathode chamber 135 also contained a drain port at the bottom connected to on/off valve 178 that allowed the liquid to be drained to waste container 190 when opened. Container 190 is vented and to the atmosphere, and no pressure buildup occurs. Tube 122 allowed the anode chamber 136 to be filled from the top by syringe pump 101 via port D. Port C of 101 was vented to ambient air via activated carbon cartridge 165. The only exit from the cathode chamber from the top was via tube 124 which led to chemiluminescence reactor 170 via normally closed on/off valve 138. With valve 138 off and the syringe 101 in any position other than B (or if in B, in locked position so it cannot be pushed back), the cathode chamber is a completely confined.

The instrument described above was controlled by a computer. A typical operational sequence was as follows.

(i) Voltage (10 V) was applied between the electrodes.

(ii) Water (2.5 mL) was aspirated into the syringe pump 101 from container 102 through port F.

(iii) The distribution valve of 101 was switched to port A and 2.5 mL of 2 M H₂SO₄ was aspirated.

(iv) The distribution valve of 101 was switched to port D and 5 mL of the water and H₂SO₄ in the syringe was dispensed at a high flow rate though tube 122 into the anode chamber, using the high flow rate of the liquid to mix the two solutions.

(v) The distribution valve of 101 was switched to port A and 1 mL of 2 M H₂SO₄ was aspirated.

(vi) The distribution valve of 101 was switched to port B. With valve 138 open for the passage of displaced air, the liquid in the syringe was dispensed via tubes 121 and 126 through the porous cathode 140 into the cathode chamber 135 of electrochemical hydride generator 132. Electrical connection is completed and hydrogen begins to evolve and escapes via tube 124, valve 138 through reactor 170 and exit 161.

(vii) Sample containing As(III) (1 mL) was aspirated into the syringe pump 101 from container 105 (or in lieu of a container, this conduit is connected to a sample source such as an autosampler or a process pipe) through port H.

(viii) The distribution valve of 101 was switched to port B. Valve 138 was turned off, completely closing the reactor. The sample was rapidly delivered into the cathode chamber. Under these conditions, the cathode chamber was mostly full of liquid leaving <1 mL gaseous headspace at the top.

(ix) The system was operated in this condition, the approximate current ranging between 0.6 to 0.7 A for 2 min. Even though this is not a very small volume thin layer cell where all the catholyte is very close to the electrode, high agitation caused by hydrogen formation and bubbling enhances mass transfer to the electrode.

(x) Valve 138 was opened, the pressurized H₂ and AsH₃ entered the chemiluminescence reactor 170 and the resulting light signal was recorded.

(xi) Valve 188 was now opened to drain the reactor contents.

(xii) The distribution valve of 101 was switched to port C. Air (10 mL) was aspirated into the syringe.

(xiii) The distribution valve of 101 was switched to port B. With valve 138 turned off, and 188 still open, air was rapidly delivered to the cathode chamber to flush remaining liquid out.

(xiv) The distribution valve of 101 was switched to port F. Water (5 mL) was aspirated in the syringe.

(xv) The distribution valve of 101 was switched to port B. The water was rapidly delivered to the cathode chamber to wash it out, with the drain valve 188 open.

(xvi) Steps xiv and xv were repeated.

(xvii) Valve 188 was closed valve 138 was opened and the system returned to step 5 to analyze the next sample.

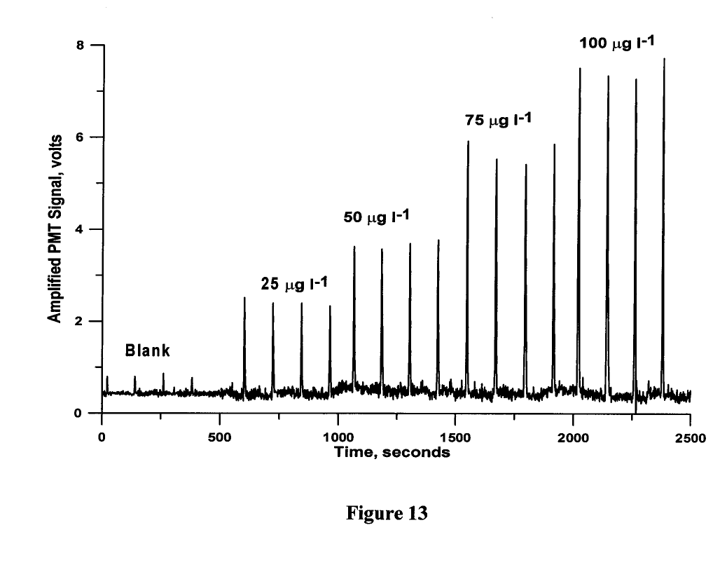

The above cycle required under 5 minutes, and measured only As(III). FIG. 13 shows representative signal output. The limit of detection based on three times the standard deviation of the blank signal was 1.2 μg/L. The response was linear up to at least 150 μg/L.

In some experiments, the cathode chamber pressure was measured with a low volume diaphragm type silicon pressure transducer. The maximum pressure was observed at the beginning of step x and did not exceed 10 psi. The valves such as 138 and 188 are inert all-fluorocarbon valves that are rated at 30 psi. Even longer electrolysis periods and the development of greater pressure will be possible.

The anode compartment does not require routine refilling. The acid in the anode compartment is not consumed; however the water is partly electrolyzed. The anode reaction is merely the consumption of water to make oxygen. Periodically, an adequate amount of water is added. At the beginning of each day, valve 178 is opened and the anode solution is drained through tube 123 into waste container 190.

### Example 25

The protocol of example 24 was modified in the following manner. After step (ix), the distribution valve of 101 is switched to port C. Air (10 mL) was aspirated into the syringe. Simultaneously with step (x), the distribution valve of 101 is switched to port B and the air rapidly dispensed thorough the porous cathode. This action purges the liquid in chamber 135 more completely of dissolved arsine and results in a higher signal.

### Example 26

This experiment was conducted identically to example 24 except that in container 105 the sample contained only As(V). No signal was observed.

### Example 27

This experiment was conducted identically to example 24 except that sulfuric acid in the cathode chamber was replaced by hydrochloric acid. Comparable signals as in example 24 were observed.

### Example 28

This experiment was conducted identically to example 24 except that sulfuric acid in the cathode chamber was replaced by nitric acid. Signals were lower and reproducibility was poor.

### Example 29

This experiment was conducted identically to example 24 except that the porous stainless steel cathode was initially first coated with cadmium as follows. The stainless steel cathode was immersed in a 0.2 M cadmium sulfate solution. A platinum wire anode was deployed with 3 V applied between them. Every 30 seconds, the electrode polarity was switched for 5 s. Electrolysis was conducted for one hour. Afterwards the coated electrode was washed thoroughly with water and annealed at 200° C. overnight. The response to samples containing As (III) was ˜20% lower than the performance described in example 24.

This experiment was conducted identically to example 26 above with the cadmium coated cathode except that in container 105, the sample contained only As(V). The response was identical to that observed for As(III) samples in example 24. Under the conditions of this experiment Total As is thus measured. Because of identical response to As(V) and As(III), either could be used as a standard for analysis with a cadmium coated electrode for Total As analysis

### Example 30

This experiment was conducted identically to example 24 except that the porous stainless steel cathode was initially first coated with lead as follows. The stainless steel cathode is electrolytically coated with lead in the same manner as cadmium coating in example 24 except using a lead acetate solution. The response for the lead coated cathode to samples containing As (III) was ˜15% lower than the performance described in example 24.

This experiment was conducted identically to example 26 above with the lead coated cathode except that in container 105, the sample contained only As(V). The response was identical to that observed for As(III) samples in example 24. Under the conditions of this experiment Total As is thus measured. Because of identical response to As(V) and As(III), either can be used as a standard for analysis with a lead coated electrode for Total As analysis.

### Example 31

This experiment was conducted identically to example 30 with a lead coated cathode except the sulfuric acid solution for adding to the cathode chamber is replaced by a buffer ranging in pH from 2-4. The response to As(III) and As(V) was tested. The two oxidation states differ in response at all pH values between 2 and 4.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The discussion of a reference herein is not an admission that it is prior art to the present invention, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A method of detecting arsenic comprising:
acidifying at least one sample comprising a known arsenic concentration;
reducing arsenic in the sample having the known arsenic concentration to arsine;
contacting the arsine in the sample having the known arsenic concentration with a reagent to produce a chemiluminescent emission;
measuring the intensity of chemiluminescent emission produced by the sample having the known arsenic concentration;
acidifying at least one sample comprising an unknown arsenic concentration;
reducing arsenic in the sample having the unknown arsenic concentration to arsine;
contacting the arsine in the sample having the unknown arsenic concentration with a photoagent to produce a chemiluminescent emission;
measuring the intensity of chemiluminescence emission produced by the sample having the unknown arsenic concentration; and
determining the arsenic content in the sample having an unknown arsenic concentration by comparing the intensity of chemiluminescent emission of the sample comprising a known arsenic concentration to the chemiluminescent emission of the sample comprising an unknown arsenic concentration, wherein the arsine is not subjected to a low-temperature trap prior to the reaction with a photoagent.

2. The method of claim 1 wherein the sample comprises an aqueous solution or suspension, a nonaqueous solution or suspension or combinations thereof.

3. The method of claim 1 wherein the samples are acidified by contact with an acid or acid-generating compound.

4. The method of claim 1 wherein the arsenic is reduced to arsine chemically, electrolytically or combinations thereof.

5. The method of claim 4 wherein the chemical reduction of arsenic comprises contacting the arsenic with a reducing agent.

6. The method of claim 5 wherein the reducing agent comprises sodium borohydride, zinc metal or combinations thereof.

7. The method of claim 4 wherein the electrolytic reduction of arsenic comprises contacting the arsenic with a platinum electrode, a cadmium electrode, a lead electrode, a stainless steel electrode or combinations thereof.

8. The method of claim 1 wherein the reagent comprises ozone.

9. The method of claim 1 wherein the low-temperature trap comprises a liquid nitrogen trap, a salt-water trap, an alcohol trap or combinations thereof.

10. A method of detecting arsenic comprising:
separating a sample into at least two portions;
adjusting the pH of a first portion to equal to or less than about 1;
adjusting the pH of a second portion to about 4;
reacting the first and second portion separately with a reducing agent to generate a first arsine sample and a second arsine sample;
reacting the first and second arsine samples separately with ozone to generate a chemiluminescence emission; and
determining the amount of arsenic present in each sample portion based on the intensity of the chemiluminescence emission.

11. A method of detecting arsenic comprising:
separating a sample into at least two portions;
adjusting the pH of a first portion to equal to or less than about 1;
reducing the first portion with a first cathode to generate a first arsine sample;
reducing the second portion with a second cathode to generate a second arsine sample;
reacting the first and second arsine samples separately with ozone to generate a chemiluminescence emission; and
determining the amount of arsenic present in each sample portion based on the intensity of the chemiluminescence emission.

12. The method of claim 11 wherein the first cathode comprises stainless steel and the second cathode comprises cadmium, lead or combinations thereof.

13. An apparatus for the measurement of arsenic in a sample comprising:
a fluid distribution system for the conveyance of fluids;
an arsine generation system in fluid communication with the fluid distribution system and receiving fluids from the fluid distribution system;
a chemiluminescence emission system in fluid communication with the arsine generation system and a photosensor, and receiving at least a portion of the sample generated from the arsine generation system; and
a detection device coupled with the photosensor,
wherein the sample may comprise arsenic in solution and the conveyance of fluids from the fluid distribution system to the arsine generation system and to the chemiluminescence emission system is synchronized.

14. The apparatus of claim 14 wherein the fluid distribution system comprises at least one multiport valve in fluid communication with one or more reservoirs for conveyance of fluid to the arsine generation system.

15. The apparatus of claim 14 wherein the arsine generation system comprises at least one reaction vessel for the reduction of arsenic to arsine.

16. The apparatus of claim 15 wherein the reaction vessel comprises a vessel for the chemical reduction of arsenic, the electrolytic reduction of arsenic or combinations thereof.

17. The apparatus of claim 16 wherein the reaction vessel for the electrolytic reduction of arsenic comprises a stainless steel cathode, a lead cathode, a platinum cathode, a cadmium cathode or combinations thereof.

18. The apparatus of claim 15 wherein the chemiluminescence emission system comprises a chemiluminescence emission cell coupled to the photosensor and in fluid communication with an ozone generation system.

19. The apparatus of claim 14 further comprising a computer controller coupled to the fluid distribution system, the arsine generation system and the chemiluminescence emission system.

20. The field deployable device for the detection of arsenic in aqueous samples comprising the apparatus of claim 14.

21. A method of detecting arsenic comprising:
adjusting the pH of a portion of a sample to about 4;
contacting the portion with a reducing agent to generate a first arsine sample;
contacting the first arsine sample with ozone to generate a chemiluminescence emission;
adjusting the pH of the first portion to less than about 1;
contacting the portion with a reducing agent to generate a second arsine sample;
contacting the second arsine sample with ozone to generate a second chemiluminescence emission; and
determining the amount of arsenic present in the trivalent and pentavalent oxidation states, based on the intensity of the first and second chemiluminescence emission.
